(19) United States
(12) Patent Application Publication
(10) Pub. No.: US 2010/0084485 A1
(43) Pub. Date: Apr. 8, 2010

(54) QUENCHED SOLIDS APPLICATOR

(75) Inventor: Timothy D. Birthisel, Perrysburg, OH (US)

Correspondence Address: GIFFORD, KRASS, SPRINKLE,ANDERSON & CITKOWSKI, P.C, PO BOX 7021, TROY, MI, 48007-7021, US

(73) Assignee: The Andersons, Inc., Maumee, OH (US)

(21) Appl. No.: 12/569,036

(22) Filed: Sep. 29, 2009

Related U.S. Application Data
(60) Provisional application No. 61/100,937, filed on Sep. 29, 2008.

(51) Int. Cl. B05B 7/08; B05B 7/24; B05B 12/00; A01C 15/00; A01C 23/00; B05B 3/00

(52) U.S. Cl. 239/10; 239/172; 239/306; 239/337; 239/418; 239/433; 239/226

(57) ABSTRACT

A quenched solids applicator includes a solids hopper for containing solids to be applied onto a foliage field or other field surface. A solids exhaust conduit terminates in an exhaust nozzle with a solids power source urging the solids from the hopper into the solids exhaust conduit and out through the exit nozzle. A liquid reservoir contains a liquid such as an aqueous based solution. The liquid exhaust conduit is also provided with a liquid pump metering liquid from the liquid reservoir to the liquid exhaust conduit having a liquid outlet in proximity to the exit nozzle to exhaust a confluent stream of quenched solids on an upward stream trajectory relative to the exit nozzle.

### CROSS-REFERENCE TO RELATED APPLICATION

This application claims priority of U.S. Provisional Patent Application Ser. No. 60/100,937 filed Sep. 29, 2008, which is incorporated herein by reference.

### FIELD OF THE INVENTION

The present invention in general relates to an apparatus and process for spray broadcast of granules or powder (hereafter called solids) onto a field or other surface with the solids being carried by a water or other liquid spray merging with the solids feed in proximity to the distribution nozzle and in particular to a process and an apparatus which reduces solids application usage rates and labor and improves application safety and precision.

### BACKGROUND OF THE INVENTION

Regardless of whether a crop grown in a field is an agricultural product, golf course grass, or other plant crop, there is routinely a need to apply substances to the field. These substances illustratively include fertilizers, seeds, insecticides, herbicides, fungicides, plant growth regulators, soil conditioners, wetting agents, repellants, attractants, inert materials like cellulose, turf topdressings, sand, clay, vermiculite, perlite, expanded minerals, any mined, manufactured, or refined solids material including biomaterials, minerals, manufactured composites, or other biologically active materials (BAIs). Traditionally, such materials have been applied as a liquid spray including the material in solution, emulsion, or suspension. While liquid spray of material onto a field or other surface has real advantages, spray drift associated with aerosolized spray solution being windblown or otherwise landing beyond the intended application boundary constitutes a significant problem. The Environmental Protection Agency (EPA) has developed a spray drift task force to explore ways to minimize this problem which can have significant health and environmental effects especially with high biological activity ingredients such as pesticides.

Another problem with the use of liquid products is the problem of accidental spills, which are difficult to contain and can cause problems ranging from monumental environmental catastrophes to the numerous incidental spills which frequently are unreported. The cumulative frequency and severity of liquid spill incidents is well recognized to add significantly to the burden of pollutants in the environment, and has led to expensive governmental regulatory requirements which have created the need for spill control systems such as sealed dikes, sumps, sorbents, and numerous service companies dedicated to environmental remediation, response and cleanup. An analogous situation exists in industry, where traditional products applied as coatings for material surfaces must be handled as slurries or liquids. These operations, such as the application of paints or colorants, corrosion inhibitors, fire retardants, cleaning agents, deicers, adhesives, etc., all suffer the problems of applying potentially hazardous and/or expensive materials in an inherently imprecise, expensive, and hazardous way as a spray application. This necessitates costly personal protective and engineering controls to protect workers, sophisticated mechanical systems for handling and distributing viscous liquids, the use of toxic, flammable and/or corrosive solvents to effect dissolution and/or dispersion of applied materials, and elaborate environmental protection systems such as vapor and aerosol collection and scrubber/filtration equipment required to minimize environmental pollution by preventing liquid spills and spray drift emissions.

The other traditional mode of material application to a field or other surface has involved broadcast distribution of solids, whether as granular materials or powder. Owing to high mass of solids relative to aerosolized liquid droplets, drift associated with solids application is largely overcome; however, solids materials may have higher material cost and suffer from the problems of dust formation and secondary solids movement associated with weather and traffic across the field. Additionally, granules are also subject to ingestion by nontarget species.

While delivery of a material to a field or other surface in a hybrid form of a slurry of particulate has been recognized as attractive hybrid that addresses many of the limitations of liquid spray and dry granule application, slurry application has proved in practice to be difficult. A slurry, as a high solids suspension, is thermodynamically unstable and solids have a tendency to settle as a function of time thereby effectively changing the concentration of slurry solids based on application time. While a stirrer within slurry application apparatus can address settling, slurry applicator devices are prone to nozzle clogging and poor control of material application rates.

Thus, there exists a need for a quenched solids applicator that joins solid and water or other liquid feeds only in proximity to a distribution nozzle and as such overcomes the shortcomings of traditional spray, dry granule, and slurry applicators.

### SUMMARY OF THE INVENTION

A quenched solids applicator includes a solids hopper for containing solids to be applied onto a foliage field or other field surface. A solids exhaust conduit terminates in an exhaust nozzle with a solids power source urging the solids from the hopper into the solids exhaust conduit and out through the exit nozzle. A liquid reservoir contains a liquid such as an aqueous based solution. The liquid exhaust conduit is also provided with a liquid pump metering liquid from the liquid reservoir to the liquid exhaust conduit having a liquid outlet in proximity to the exit nozzle to exhaust a confluent stream of quenched solids on an upward stream trajectory relative to the exit nozzle.

A process for applying solids onto a field is also provided that includes feeding dry solids to an exit nozzle with a given velocity. The dry solids are exhausted from the exit nozzle with a solids trajectory that contacts a liquid stream having a greater velocity than the solids velocity. The contact between the liquid stream and dry solids occurs in proximity to the exit nozzle to form a confluent stream that is applied onto the field at an upward stream trajectory. Alternatively, a process is provided in which dry solids are fed to an exit nozzle and mixed with a higher velocity liquid stream, mixing occurring in proximity to the exit nozzle to form a confluent stream that is applied onto the foliage field in an upward stream trajectory.

### BRIEF DESCRIPTION OF THE DRAWINGS

The present invention is further detailed with respect to the following figures in which the relative size of inventive applicator components has been distorted for visual clarity.

FIG. 1 is a partial cutaway, exploded schematic of an inventive quenched solids applicator having a liquid propellant stream joining the solids feed at the granule feed outlet; and

FIG. 2 is a partial cutaway, exploded schematic of an inventive quenched solids applicator having a liquid propellant stream joining the solids feed into the granule feed outlet to provide a unified liquid-solids expulsate.

### DETAILED DESCRIPTION OF THE INVENTION

The present invention has utility in the application of solids materials onto a field of foliage or other field surface. By creating a confluence of a liquid stream and a solids stream external to or proximal to an exit nozzle, granule dust formation and spray drift associated with solids and liquid spray application, respectively, are inhibited while precluding fouling. By limiting to liquid-solids confluent stream time within an inventive applicator, fouling common to slurry application is limited. A controller to adjust flow conditions of the liquid stream and the solids stream assures a desired confluent stream expulsate is delivered to a field. The optional addition of exit nozzle oscillator mechanism compensates for expulsate density distribution associated with the exit nozzle configuration. Wetting a solid exterior to an exit nozzle facilitates adhesion to field foliage or other field surfaces while preventing nozzle fouling associated with slurry delivery.

As used herein, “foliage” is defined to include a field on which desirous plants are grown. Specific exemplary fours of foliage illustratively include turf grass, grain crops, orchards, tubers, legumes, vegetables, ornamentals, and hay. Other field surfaces can be any surface of components or structures used in the home, in farming or in industry, whether exterior or interior, and other plant parts such as tree trunks or plant stems.

Solids applied to a foliage field or other field surfaces by an inventive applicator are virtually without limit as to components or structure with the proviso that a solids component promotes growth of target foliage. It is appreciated that solids that disintegrate upon contact with water provide the attribute of dispersing rapidly into soil while solids that retain integrity during transit in a liquid stream for the attribute of slow release of components or buildup of a loose field over layer. As such, the present invention is operative to deliver solids components as diverse as fertilizers, herbicides, insecticides, soil amendments, turf top dressings, nematicides, fungicides, and hormones.

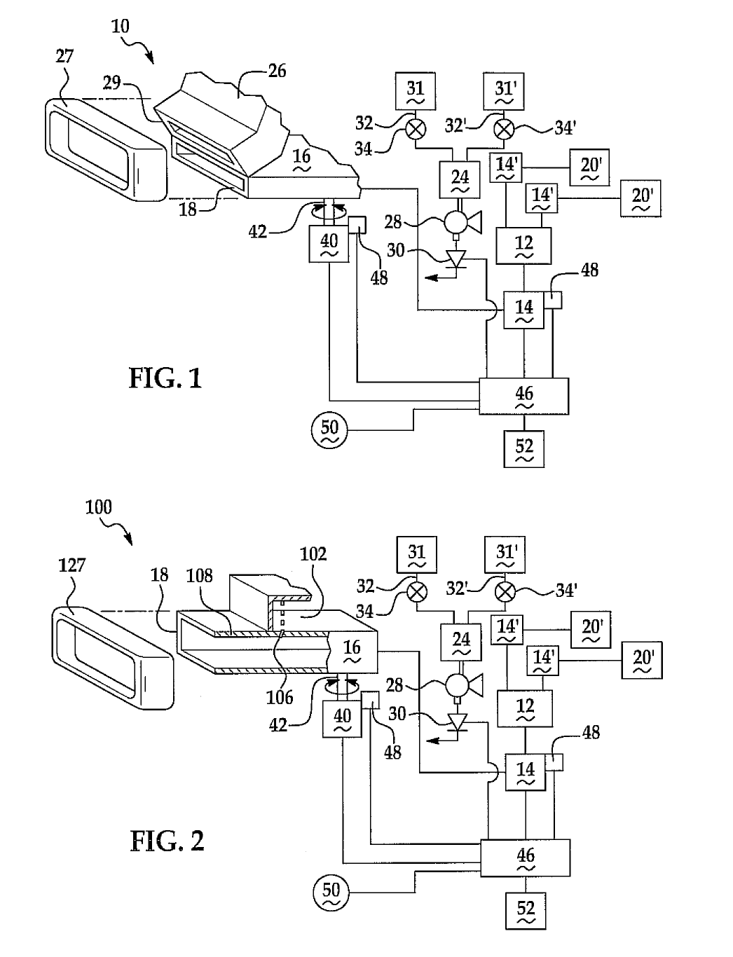

The present invention is further illustrated with respect to FIG. 1 in which an inventive quenched solids applicator is depicted generally at 10 and includes a solids hopper 12 for containing solids to be dispersed onto a field of foliage. A solids power source 14 is in communication with the solid hopper 12 and conveys solids from the hopper 12 into a solids exhaust conduit 16, the exhaust conduit 16 terminating in an exit nozzle 18. A solid power source 14 includes a variety of conventional power sources, and it is appreciated that the nature of an inventive applicator as a handheld or vehicle mounted unit has implications in the nature of the solids power source 14. Illustrative solid power sources 14 include an auger, smooth belt, pocketed belt, drag, bucket elevator, flywheel, conveyors, centrifugal paddlewheels, diaphragm pumping, and pneumatic blowers. With operation of the solid power source 14, solids are delivered as a function of solids power source operation conditions through the exit nozzle 18 at a controlled velocity and delivery rate in units of weight per unit time. While exit nozzle 18 is depicted in FIG. 1 with a horizontal orthogonal axis, it is appreciated that in operation other axial arrangements relative to an underlying foliage field are operative including a vertical orthogonal axis. Optionally, one or more solids component bins 20 and 20′ are in communication with the solids hopper 12 by way of solids metering conduits 22 and 22′, respectively, to provide dynamic mixing within the solids hopper 12 of solids components to be delivered via solids hopper 12. By way of illustration, representative materials placed within solids component bins 20 and 20′ illustratively include: solids of fertilizer-pesticide, sand-bioactive containing solids, and sand-bioactive coated sand. The solids metering conduits 22 and 22′, if present, include solids component power sources 14′ which are the same as those detailed with respect to solids power source 14. In instances when solids hopper 12 is fed by solids component bins 20 and 20′, an internal mechanical mixer (not shown) is optionally incorporated within solids hopper 12.

A liquid reservoir 24 is provided for containing a liquid. The liquid reservoir 24 is expected in most instances to deliver water or an aqueous based solution. In order to overcome the limitations associated with liquid spray of an atomized noxious or bioactive substance, preferably the liquid within the liquid reservoir is considered environmentally benign as being a substance not regulated under existing Environmental Protection Agency regulations. The liquid reservoir 24 is in fluid communication with a liquid exhaust conduit 24 by way of a liquid pump 28. The liquid pump 28 meters liquid from the liquid reservoir 24 to the liquid exhaust conduit 26. The liquid exhaust conduit 26 has a liquid outlet 29 in proximity to the exit nozzle 18. The liquid pump 28 is of a form that illustratively includes a diaphragm pump and a pneumatic blower. It is appreciated that based on the nature of the liquid pump 28, some such pumps best operate at constant speed and the quantity of liquid conveyed to liquid exhaust conduit 26 is controlled by a valve 30. As shown in FIG. 1, the liquid outlet 29 is coterminous with exit nozzle 18 yet angled relative to exit nozzle 18 to create a line intersection confluence of fluid and solids streams. It is appreciated that while nozzle 18 and outlet 29 are depicted as rectilinear, contiguous and like sized areas, other shapes and relationships between exit nozzle 18 and exhaust outlet 29 are operative herein and considered part of the present invention. By way of example, each of the exhaust nozzle 18 and liquid outlet 29 are independently shaped to have an exhaust cross section that is circular, oval, rectangular, and a manifold of segmented apertures. The relationship between the exit nozzle 18 and outlet 29 is appreciated to need not be contiguous as detailed with respect to FIG. 1 and also includes circumventing, adjacent or laterally shifted.

Regardless of the specifics of exit nozzle 18 and outlet 29 configuration, a critical aspect of the present invention is that solids exhaust stream made confluent with liquid exhaust stream is adherent on contact with foliage, yet does not foul or generate waste slurry, as are currently common events. Additionally, when the liquid velocity is greater than the solids velocity, exhausted solids are accelerated by mixing with the liquid exhaust to increase both the broadcast distance and uniformity relative to conventional broad solids or slurry applicators. The confluent stream trajectory has an upward and outward component with the trajectory peak extending above the exit nozzle and preferably above the liquid reservoir. Trajectory angles of 20 to 50 degrees relative to the horizon are typical. Optionally, a spout 27 engages the exit nozzle 18 and liquid outlet 29 to modify the exhaust profile of the applicator 10.

Optionally, liquid reservoir 24 is in fluid communication with one or more liquid component tanks 31 or 31′ by way of reservoir fill conduit 32 or 32′. Metering valves 34 and 34′ regulate flow of liquids from tanks 31 and 31′, respectively, to the reservoir 24. A mechanical stirrer, bubbler or other form of agitation is optionally included within reservoir 24 to assure homogeneous liquid mixing within reservoir 24. Exemplary liquid feeds to the reservoir 24 include biologics such as bacterial solutions. In recognition of the exhaust profile of a given applicator 10, a motor 40 is provided to cause an inventive exit nozzle 18 and liquid outlet 29 to pivot or oscillate thereby broadening the swath of field that can be sprayed in a given pass. The motor 40 is in mechanical communication with the liquid exhaust conduit and solids exhaust conduit by way of a spindle 42. Additionally, through inclusion of a pivoting or oscillating movement, the application profile of the inventive applicator that tends to apply larger amounts of material from the central core of a nozzle relative to the edges is addressed in a compensation that results in more uniform and efficient application, especially from large vehicle mounted embodiments of an inventive applicator.

A large vehicle mounted embodiment of an inventive applicator, as compared to a handheld applicator, benefits from the inclusion of a computer controller 46. The computer controller 46 operates components of an inventive applicator 10 including at least one of solids power source 14, pump 28, valve 30, motor 40, solids component metering power sources 14′, valve 34 or valve 34′. Preferably, the computer controller 46 operates all components associated with the operation of an inventive applicator 10. More preferably, the quantity of solids and liquid being exhausted is controlled to deliver a given ratio of liquid:solids at a preselected velocity to achieve a desired application density on a foliage field. Still more preferably, the computer controller 46 includes feedback sensors depicted graphically generically at 48, as well as a speedometer 50 to adjust applicator output to the ground speed at which the applicator is transiting across a foliage field. Through dynamic control of liquid and solids feed rates and quantities, solids and liquid are applied to a foliage field under controlled exhaust conditions from an inventive applicator with controls as to velocity and application density. A user manual input of operational parameters 52 is optionally provided to the controller 46.

An inventive applicator 100 is depicted in FIG. 2 where like numerals used with respect to FIG. 1 are intended to have the same meaning as previously attributed to these numerals. The applicator 100 has a liquid exhaust conduit 102 in fluid communication with the reservoir 24 by way of pump 28 and valve 30, with the liquid exhaust conduit 102. Through one or more apertures 106 formed in the wall 108 of the solids exhaust conduit 16, pressurized liquid is exhausted from the exhaust conduit 102 into the solids exhaust conduit 16. Preferably the apertures 106 are within 10 centimeters of the exit nozzle 18. It is appreciated that the higher the solids exhaust velocity the further removal apertures 106 are from the exit nozzle 18 are tolerated. Preferably, the one or more apertures 106 are angled towards exit nozzle 18 to promote confluent exhaust of solids and liquid from exit nozzle 18. It is appreciated that with resort to multiple spiral apertures 106, vortex flow from exit nozzle 18 is achieved. Optionally a spout 127 engages the exit nozzle 18 to modify the exhaust profile of the applicator 100.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A quenched solids applicator comprising:
a solids hopper for containing solids;
a solids exhaust conduit terminating in an exit nozzle;
a solids power source urging said solids from said hopper into said solids exhaust conduit and out through said exit nozzle;
a liquid reservoir for containing a liquid;
a liquid exhaust conduit; and
a liquid pump metering said liquid from said liquid reservoir to said liquid exhaust conduit, said liquid exhaust conduit having a liquid outlet in proximity with said exit nozzle to exhaust a confluent stream of quenched solids on an upward stream trajectory relative to said exit nozzle.

2. The applicator of claim 1 wherein said liquid outlet is rectilinear and contiguous to said exit nozzle.

3. The applicator of claim 2 wherein said exit nozzle is rectilinear.

4. The applicator of claim 1 wherein said liquid outlet is angled relative to said exit nozzle.

5. The applicator of claim 1 wherein said liquid outlet is in fluid communication with said solids exhaust conduit through at least one aperture through a wall of said solids exhaust conduit.

6. The applicator of claim 5 wherein the at least one hole is within 10 centimeters of said exit nozzle.

7. The applicator of claim 1 further comprising a spout engaging said exit nozzle.

8. The applicator of claim 1 further comprising a computer controller operating at least one of said solids power source and said liquid pump.

9. The applicator of claim 8 further comprising a sensor providing feedback to said computer controller as to the operation of one of said solids power source or said liquid pump.

10. The applicator of claim 8 further comprising a speedometer providing said computer controller with information as to travel ground speed of the applicator and a power train for moving the applicator.

11. The applicator of claim 1 further comprising a motor in mechanical communication with said solids exhaust conduit and said liquid exhaust conduit to induce a pivot or oscillation.

12. The applicator of claim 1 further comprising a solids component bin in solids communication with said solids hopper.

13. The applicator of claim 12 further comprising a liquid storage tank in fluid communication with said liquid reservoir.

14. A process of applying solids onto a field comprising:
feeding a plurality of dry solids to an exit nozzle at a solids velocity;
exhausting said plurality of dry solids from the exit nozzle with a solids trajectory;
contacting said plurality of dry solids while on the trajectory with a liquid stream having a liquid velocity greater than the solids velocity in proximity to the exit nozzle to form a confluent stream that is applied onto the field at an upward stream trajectory.

15. The process of claim 14 further comprising:
exhausting said plurality of dry solids with a solids power source and pumping the liquid stream with a liquid pump; and
controlling said liquid pump with a computer controller responsive to at least one of the solids velocity and the liquid velocity.

16. The process of claim 15 further comprising transiting the foliage field simultaneously with the confluent stream applied onto the field.

17. The process of claim 14 further comprising pivoting or oscillating the exit nozzle simultaneously with the confluent stream applied onto the field.

18. A process of applying solids onto a field comprising:
feeding a plurality of dry solids to an exit nozzle at a solids velocity; and
mixing said plurality of dry solids with a liquid stream having a liquid velocity greater than the solids velocity in proximity to the exit nozzle to form a confluent stream that is applied onto the field at an upward stream trajectory.

19. The process of claim 18 further comprising:
feeding said plurality of dry solids with a solids power source and pumping the liquid stream with a liquid pump; and
controlling said liquid pump with a computer controller responsive to at least one of the solids velocity and the liquid velocity.

20. The process of claim 19 further comprising transiting the foliage field simultaneously with the confluent stream applied onto the field.

21. The process of claim 18 further comprising pivoting or oscillating the exit nozzle simultaneously with the confluent stream applied onto the field.
